(19) United States
(12) Patent Application Publication
(10) Pub. No.: US 2025/0229402 A1
(43) Pub. Date: Jul. 17, 2025

(54) CAMSHAFT FOR POWER TOOL

(71) Applicant: MILWAUKEE ELECTRIC TOOL CORPORATION, Brookfield, WI (US)

(72) Inventors: Xiao Long Le, Ji An City (CN); Wei Chao Xu, Dongguan City (CN); Yang Zhen Bo, Dongguan City (CN); Ethan McKenzie, Brookfield, WI (US)

(21) Appl. No.: 19/016,953

(22) Filed: Jan. 10, 2025

Related U.S. Application Data
(60) Provisional application No. 63/620,557, filed on Jan. 12, 2024.

(51) Int. Cl. B25F 5/00; B25B 21/02; B25F 5/02

(52) U.S. Cl. CPC B25F 5/001; B25B 21/02; B25F 5/02

(57) ABSTRACT

A power tool including a housing, a motor supported within the housing and including an output shaft, a transmission assembly, and an impact mechanism. The motor is configured to rotationally drive the output shaft. The transmission assembly is configured to be rotationally driven by the output shaft. The impact mechanism includes a camshaft configured to be rotationally driven by the transmission assembly, a hammer, and an anvil. The camshaft has a groove, and at least a portion of the groove is defined by an equation selected from a group consisting of: trigonometric equations and higher order differential equations. The hammer is coupled to the camshaft by a cam ball received in the groove. The anvil is configured to receive intermittent rotational impacts from the hammer.

### CROSS-REFERENCE TO RELATED APPLICATIONS

The present application claims priority to U.S. Provisional Patent Application No. 63/620,557, filed Jan. 12, 2024, the entire content of which is incorporated herein by reference.

### FIELD

The present disclosure relates to power tools with impact mechanisms, and more specifically, to power tools with rotational impact mechanisms (“rotary impact tools), such as impact drivers, impact wrenches, and the like.

### BACKGROUND

Rotary impact tools typically include a hammer coupled to a camshaft such that the hammer can reciprocate along the camshaft, storing energy in a spring, and also to rotate relative to the camshaft to deliver periodic rotational impacts to an anvil.

### SUMMARY

The reciprocation of the hammer along the camshaft produces axial vibrations, which can result in user discomfort and fatigue. Accordingly, the present disclosure may provide, among other things, a camshaft configured to provide a rotary impact type power tool with smoother operation and less vibration.

For example, in one aspect, the techniques described herein relate to a power tool including: a housing; a motor supported within the housing and including an output shaft, the motor configured to rotationally drive the output shaft; a transmission assembly configured to be rotationally driven by the output shaft; and an impact mechanism including a camshaft, a hammer, and an anvil. The camshaft is configured to be rotationally driven by the transmission assembly. The camshaft has a groove, and at least a portion of the groove is defined by an equation selected from a group consisting of: trigonometric equations and higher order differential equations. The hammer is coupled to the camshaft by a cam ball received in the groove. The anvil is configured to receive intermittent rotational impacts from the hammer.

In some aspects, the portion of the groove is defined by a cosine equation. In further aspects, the hammer is configured to rotationally impact the anvil when the cam ball is in the portion of the groove defined by the cosine equation.

In some aspects, the portion of the groove is a first groove portion, and the groove includes a second groove portion defined by a linear equation. In further aspects, the first groove portion and the second groove portion meet at a transition point, and the first groove portion and the second groove portion are continuous and tangential at the transition point. In further aspects, the groove includes a third groove portion defined by an equation for a circle. In further aspects, the groove includes two second groove portions and the first groove portion extends between the two second groove portions, and the groove includes two third groove portions and each of the third groove portions extends from a corresponding one of the second groove portions.

In some aspects, the entire groove is defined by the equation selected from a group consisting of: trigonometric equations and higher order differential equations.

In some aspects, the camshaft extends along an axis, and the groove is mirrored across the axis.

In another aspect, the techniques described herein relate to a camshaft for an impact mechanism, the camshaft including a groove configured to receive a cam ball, the groove including a first portion defined by a first equation, a second portion defined by a second equation, and a third portion defined by a third equation, wherein at least one of the first equation, the second equation, and the third equation is an equation selected from a group consisting of: trigonometric equations and higher order differential equations.

In some aspects, only one of the first equation, the second equation, and the third equation is an equation selected from the group consisting of: trigonometric equations and higher order differential equations.

In some aspects, the first equation is a cosine equation having an amplitude, the amplitude of the cosine equation defines a forward-most point of the groove, the second groove portion extends from an end of the first groove portion opposite from the amplitude, and the third groove portion extends from an end of the second groove portion opposite from the first groove portion. In further aspects, the camshaft extends along an axis, and the groove is mirrored across the axis such that the groove includes two second groove portions and two third groove portions. In further aspects, the second equation is a linear equation, and the third equation is an equation for a circle.

In some aspects, each of the first equation, the second equation, and the third equation are different types of equations.

In yet another aspect, the techniques described herein relate to a power tool including a housing, a motor supported within the housing and including an output shaft, a transmission assembly, and an impact mechanism. The motor is configured to rotationally drive the output shaft. The transmission assembly is configured to be rotationally driven by the output shaft. The impact mechanism includes a camshaft, a hammer, and an anvil. The camshaft is configured to be rotationally driven by the transmission assembly. The camshaft has a groove with a first groove portion and a second groove portion that meet at a transition point. The first groove portion and the second groove portion are continuous and tangential at the transition point. The hammer is coupled to the camshaft by a cam ball received in the groove. The anvil is configured to receive intermittent rotational impacts from the hammer.

In some aspects, the first groove portion is defined by a first equation and the second groove portion is defined by a second equation, and wherein the first equation and the second equation are different. In further aspects, one of the first equation and the second equation is an equation selected from a group of equations consisting of: trigonometric equations and higher order differential equations, and the other of the first equation and the second equation is a linear equation.

In some aspects, the transition point is a first transition point, the groove further including a third groove portion such that the second groove portion and the third groove portion meet at a second transition point, and the second groove portion and the third groove portion are continuous and tangential at the second transition point. In further aspects, each of the first groove portion, the second groove portion, and the third groove portion is defined by a different equation from the other of the first groove portion, the second groove portion, and the third groove portion.

### BRIEF DESCRIPTION OF THE DRAWINGS

FIG. 1 is a perspective view of an impact wrench according to an embodiment of the disclosure.

FIG. 2 is a cross-sectional view of the impact wrench of FIG. 1 taken along line 2-2.

FIG. 3 is a perspective view of a camshaft and a hammer for the impact wrench of FIG. 1.

FIG. 4 is a plan view of the camshaft of FIG. 3.

FIG. 5 is a schematic view of a cam groove for the camshaft of FIG. 4.

FIG. 6 illustrates a graph having position, velocity, and acceleration curves for a prior art camshaft.

FIG. 7 illustrates a graph having position, velocity, and acceleration curves for the camshaft of FIG. 4.

FIG. 8A is a plan view of a camshaft according to another embodiment of the disclosure.

FIG. 8B is another plan view of the camshaft of FIG. 8A.

FIG. 8C is a perspective view of the camshaft of FIG. 8A.

FIG. 9 illustrates a graph having position, velocity, and acceleration curves for a camshaft according to another embodiment of the disclosure.

Before any embodiments of the disclosure are explained in detail, it is to be understood that the disclosure is not limited in its applications to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

### DETAILED DESCRIPTION

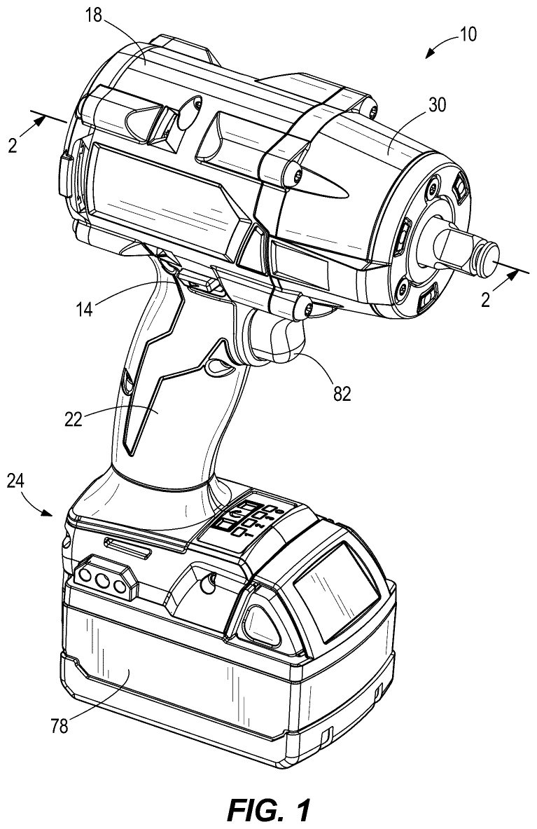

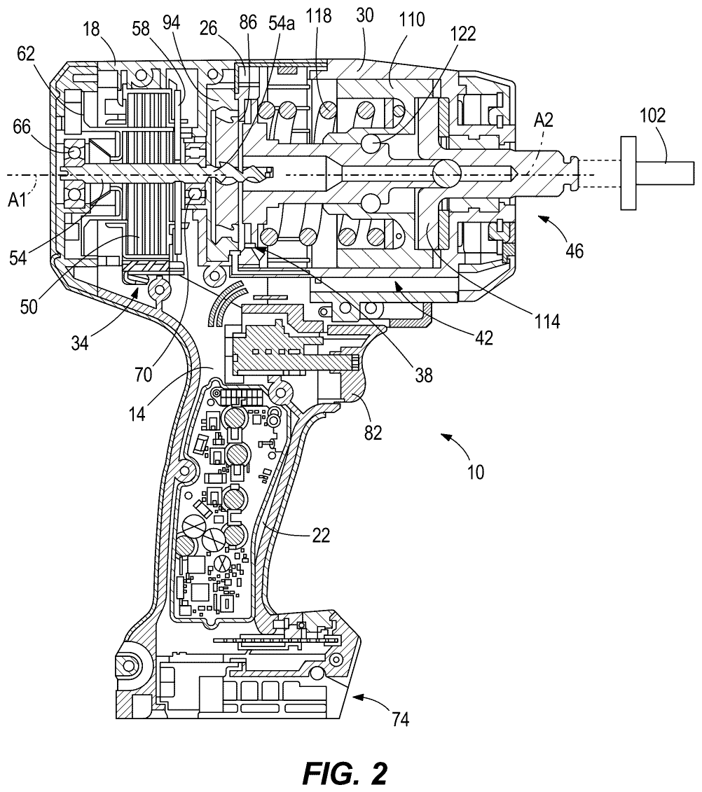

FIGS. 1 and 2 illustrate a power tool in the form of an impact wrench 10. The impact wrench 10 includes a housing 14 having a drive unit housing portion 18, a handle housing portion 22 extending downwardly from the drive unit housing portion 18, an intermediate case 26, and an impact case or front housing portion 30 coupled to and extending forwardly of the drive unit housing portion 18. In the illustrated embodiment, the drive unit housing portion 18 and the handle housing portion 22 are defined by cooperating first and second clamshell halves or housing portions. The drive unit housing portion 18 houses a drive unit 34 that is configured to produce, or generate, a torque output. The handle housing portion 22 defines a grip configured to be grasped by a user for operation of the impact wrench 10. The intermediate case 26 houses a transmission assembly 38 configured to receive torque from the drive unit 34. The drive unit 34 and the transmission assembly 38 form a drive assembly. The front housing portion 30 houses an impact mechanism 42 which is configured to receive torque from the transmission assembly 38 and provide, or deliver, torque at an output end 46 of the impact wrench 10.

With continued reference to FIGS. 1 and 2, the drive unit 34 includes a motor 50, an output shaft 54 configured to be driven by the motor 50 to provide a torque output, a printed circuit board assembly (“PCBA”) 58 for controlling operation of the motor 50, and a fan 62 mounted to the output shaft 54. The motor 50 is a brushless direct current (“BLDC”) motor. As such, the motor 50 may include a stator and a rotor. The output shaft 54 defines a motor axis A1. The output shaft 54 is supported by a rear bearing 66 and a front bearing 70. Both the rear bearing 66 and the front bearing 70 are supported by the drive unit housing portion 18. In the illustrated embodiment, the PCBA 58 is positioned between the motor 50 and the front bearing 70. In other embodiments, the PCBA 58 may be positioned elsewhere. The fan 62 is mounted to the output shaft 54 at a position located between the motor 50 and the rear bearing 66. As such, the motor 50 is configured to drive rotation of the fan 62. As the fan 62 rotates, the fan 62 may induce a flow of cooling air to flow past the motor 50 to cool the motor 50 and the PCBA 58.

The handle housing portion 22 defines the grip and a battery receptacle 74 that receives a battery 78 configured to supply electricity to the motor 50. The battery 78 may be a power tool battery pack generally used to power a power tool, such as an electric drill (e.g., an 18 volt rechargeable battery, or an M18 REDLITHIUM battery pack sold by Milwaukee Electric Tool Corporation). The battery 78 may include lithium ion (Li-ion) cells. In alternate embodiments, the battery 78 may be of a different chemistry (e.g., nickel-cadmium (NiCa or NiCad), nickel-hydride, and the like). In the illustrated embodiment, the battery 78 may be a 4 volt battery pack, a 28 volt battery pack, a 40 volt battery pack, or a battery pack of any other voltage suitable for powering the impact wrench 10. The grip supports a switch 82 (e.g., a trigger switch) that is actuatable to electrically connect the motor 50 and the battery 78 to provide DC power to the motor 50. As such, a user may actuate the switch 82 to send a signal to the PCBA 58 to energize the motor 50 such that the drive unit 34 begins produce torque.

As illustrated in FIGS. 2-4, the transmission assembly 38 includes a planet carrier 86, a plurality of planet gears 90, and a ring gear 94. The planet carrier 86 supports the plurality of planet gears 90. The planet carrier 86 may include a rear wall 86a, a front wall 86b, and a plurality of pins 98 extending between the rear wall 86a and the front wall 86b such that each of the planet gears 90 is mounted, or coupled, to a corresponding one of the pins 98 between the rear wall 86a and the front wall 86b. Each of the planet gears 90 includes gear teeth that are in meshed engagement with a pinion 54a of the output shaft 54 such that rotation of the output shaft 54 drives movement and rotation of the planet gears 90. Each of the planet gears 90 is also in meshed engagement with ring gear teeth that are formed on an inner surface of the ring gear 94. As such, the output shaft 54 is configured to drive rotation of the planet gears 90 around the ring gear 94 such that the planet gears 90 orbit around the pinion 54a of the output shaft 54. Due to the coupling between the planet gears 90 and a corresponding one of the pins 98, the planet gears 90 provide a constant rotational force or torque to the planet carrier 86.

With continued reference to FIGS. 2-4, the impact mechanism 42 is configured to convert the constant rotational force or torque provided by the transmission assembly 38 into a striking rotational force or intermittent applications of torque at the output end 46 of the impact wrench 10 for application to the workpiece 102. The impact mechanism 42 includes a camshaft 106, a hammer 110, an anvil 114, and a spring 118. The camshaft 106 is integrally formed with the planet carrier 86 of the transmission assembly 38 such that the motor 50 may provide constant rotational force or torque to the camshaft 106 through the meshed engagement between the output pinion 54a and the planet gears 90. The camshaft 106 extends along an axis of rotation A2. The axis of rotation A2 may also be referred to as an output axis. In the illustrated embodiment, the axis of rotation A2 is coaxial with the motor axis A1. The camshaft 106 includes at least one cam groove 122 defined in the camshaft 106 that is configured to receive at least one cam ball 126. The cam ball 126 is positioned in driving engagement with the hammer 110 such that movement of the cam ball 126 within the cam groove 122 allows for relative axial movement of the hammer 110 along the camshaft 106. Specifically, the hammer 110 is configured to move axially along the camshaft 106 to intermittently apply a striking rotational force, or rotational impact, on the anvil 114. The spring 118 extends from the planet carrier 86 to the hammer 110 and biases the hammer 110 toward the anvil 114.

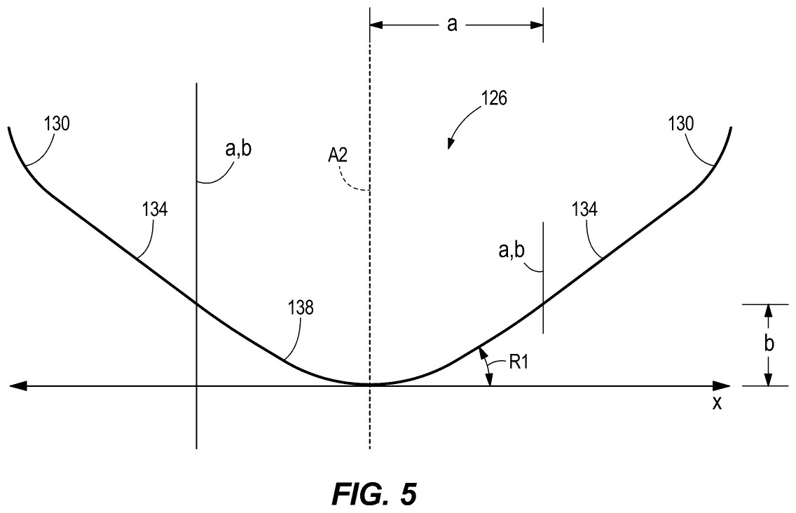

In the illustrated embodiment, with reference to FIG. 4, the cam groove 122 has a first groove portion 130, a second groove portion 134, and a third groove portion 138. The designation of first, second, and third is arbitrary such that the groove portions 130, 134, 138 may be referred to in any other order. For example, the first groove portion 130 could be referred to as the third groove portion, and the third groove portion 138 could be referred to as the first groove portion. The first groove portion 130 defines a first end of the cam groove 122. When the cam ball 126 is positioned in the first portion 130 of the cam groove 122, the hammer 110 may be at a rearward-most position along the camshaft 106. The second groove portion 134 extends between the first portion 130 and the third groove portion 138. The third groove portion 138 defines a second end of the cam groove 122. When the cam ball 126 is positioned in the third groove portion, the hammer 110 is in a forward-most position along the camshaft 106 such that the hammer 110 may strike the anvil 114. In the illustrated embodiment, the cam groove 122 is mirrored across the output axis A2 along a circumference, or outer surface, of the camshaft 106. As such, the cam groove 122 includes two first groove portions 130 and two second groove portions 134. The third groove portion 138 extends between and connects the two second groove portions 134 such that the cam ball 126 can travel sequentially from the first groove portion 130 and the second groove portion 134 on one side of the output axis A2, across the third groove portion 138, and along the second groove portion 134 and the first groove portion 130 on the opposite side of the output axis A2. Stated another way, each of the second groove portions 134 extends from an end of the third groove portion 138 opposite from the output axis A2 (i.e., the amplitude, or the forward-most position of the third groove portion 138), and each of the first groove portions 130 extends from an end of a corresponding one of the second groove portions that is opposite from the third groove portion 138.

The first groove portion 130 is defined by a first equation, the second groove portion 134 is defined by a second equation, and the third groove portion is defined by a third equation. In the illustrated embodiment, each of the first equation, the second equation, and the third equation is different from one another. In other words, the first groove portion 130, the second groove portion 134, and the third groove portion 138 are each defined by different equations. In some embodiments, the first equation, the second equation, and the third equation may all be the same. In further embodiments, the groove may only have one portion defined by a single equation. As will be described in more detail below, the third equation is an equation selected from a group consisting of: trigonometric equations and higher order differential equations.

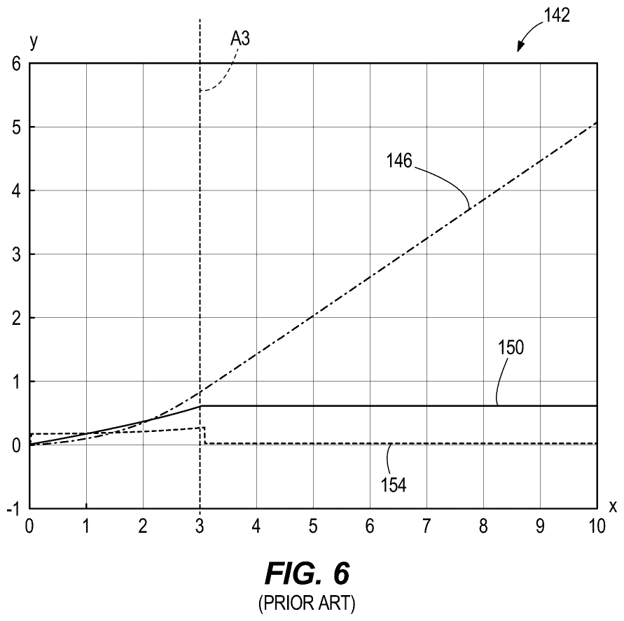

With reference to FIGS. 4 and 5, each of the first groove portion 130 and the second groove portion 134 is described below with respect to just one of the portions 130, 134 (i.e., the portion 130, 134 on the one side of the output axis A2). It is understood that the description of each of the first groove portion 130 and the second groove portion 134 on the one side of the output axis A2 applies equally to the corresponding portion 130, 134 on the opposite side of the output axis A2. In some embodiments, the portions 130, 134 on the one side of the output axis A2 may be different than the corresponding portions 130, 134 on the opposite side of the output axis A2. In the illustrated embodiment, the first groove portion 130 is defined by a specific radius. In other words, the first groove portion 130 is defined by a portion of a circle having the radius. As such, the first groove portion 130 follows the equation of a circle, as follows:

$${r}^{2} = {( x - A )}^{2} + {( y - B )}^{2}$$

In this equation, the variables A and B set the location of the center of the circle. For example, the variable A sets the x-coordinate on an x-y coordinate system, and the variable B sets the y-coordinate on an x-y coordinate system. As such, the variables A and B can be adjusted to set the starting location of the first groove portion 130 (e.g., to align with the second groove portion 134). The variable r is the radius of the circle. As such, the variable r can be adjusted to set the curvature of the first groove portion 130 from the starting location (e.g., to align with the second groove portion 134). Specifically, the first groove portion 130 and the second groove portion 134 meet at a transition point, and the equation of the circle may be determined so that the first groove portion 130 and the second groove portion 134 are continuous and tangential at the transition point. The transition point between the first groove portion 130 and the second groove portion 134 may be referred to as a first or second transition point.

In the illustrated embodiment, the second groove portion 134 extends linearly between the first groove portion 130 and the third groove portion 138. Specifically, the second groove portion 134 extends at an alpha angle R1 relative to a horizontal axis (e.g., an x-axis on an x-y coordinate system). As such, the second groove portion 134 is defined by a linear, slope-intercept form equation, as follows:

$$y = C x + D$$

In this equation, the variable C is the slope at which the second groove portion 134 extends. As such, the variable C can be adjusted according to a desired value for the alpha angle R1. The variable D sets the starting location of the second groove portion 134. As such, the variable D can be adjusted according to desired starting and end locations of the second groove portion 134.

In the illustrated embodiment, the third groove portion 138 extends between the two second groove portions 134. Specifically, the third groove portion 138 curves between the two second groove portions 134 such that the third groove portion 138 is mirrored across the output axis A2. More specifically, the third groove portion 138 curves from each of the second groove portions 134 to the output axis A2 according to one equation from a group of equations including trigonometric equations and higher order differential equations. In other words, the third groove portion 138 is defined by one equation from a group of equations including trigonometric equations and higher order differential equations. The trigonometric equations may include one or more trigonometric ratios of an angle, such as sine, cosine, tangent, cotangent, secant, or cosecant. The higher order differential equations may be, for example, second order differential equations, third order differential equations, etc. In the illustrated embodiment, the trigonometric equation defining the third groove portion 138 is the cosine equation such that the third groove portion 138 is a cosine curve, as follows:

$$Y = ( - E ) cos ( F ( x - G ) ) + H$$

In this equation of the cosine curve, the variable E defines the amplitude of the cosine curve. As such, the variable E can be adjusted to set the height of curvature for the cosine curve, and thus set the forward-most point of the groove 122. The variable F defines the period of the cosine curve. As such, the variable F can be adjusted to set the length of curvature for the cosine curve. The variable G defines the phase shift of the cosine curve. As such, the variable G can be adjusted to set the x-coordinate of the cosine curve on an x-y coordinate system. The variable H defines the vertical shift of cosine curve. As such, the variable H can be adjusted to set the y-coordinate of the cosine curve on an x-y coordinate system.

The one equation may also be referred to as a first equation, and the group of equations may also be referred to as a first group of equations. As such, the second groove portion 134 extends between the first groove portion 130 and the third groove portion 138 according to another one equation (e.g., a second equation) from a second group of equations including, at least, the linear or slope-intercept form equation. In other words, the second groove portion 134 is defined by a second equation from a second group of equations. The second group of equations may further include, for example, the equation of a circle. In some embodiments, the second group of equations does not include trigonometric equations or higher order differential equations.

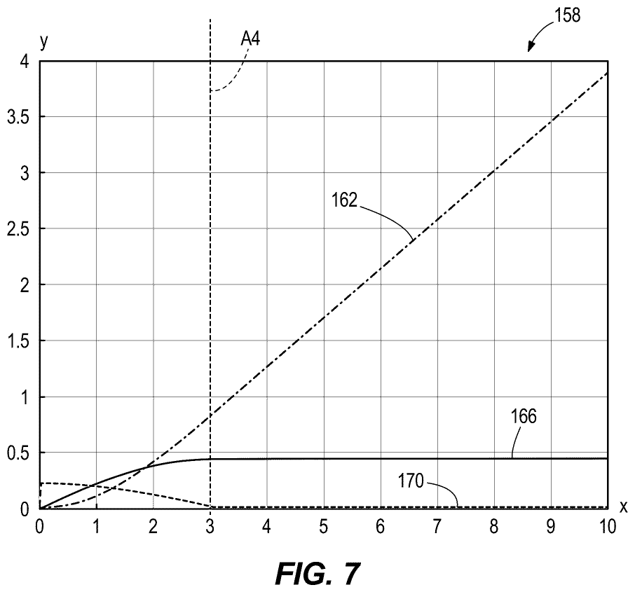

The third groove portion 138 provides a continuous and tangential transition between the second groove portion 134 and the third groove portion 138 that removes sudden jerks or accelerations of the hammer 110 during operation of the impact mechanism 42. For example, FIG. 6 is a graph 142 illustrating a position curve 146, a velocity curve 150, and an acceleration curve 154 for a camshaft having a conventional cam groove defined partly by a circular (radius) function and a linear equation. As illustrated in FIG. 6, a line A3 indicates the position of a transition point between a second groove portion and a third groove portion for the conventional cam groove (e.g., where the second groove portion and the third groove portion meet) relative to the position, velocity, and acceleration curves 146, 150, 154 of a cam ball traveling along the conventional cam groove. During operation of the camshaft having the conventional cam groove, when the cam ball reaches the transition point, travel of the cam ball may impact or be interrupted by a sudden change in acceleration, represented as a step in the acceleration curve 154, between the second groove portion and the third groove portion. This sudden change in acceleration, illustrated at line A3 in FIG. 6, causes the cam ball, and therefore, the hammer, to jerk.

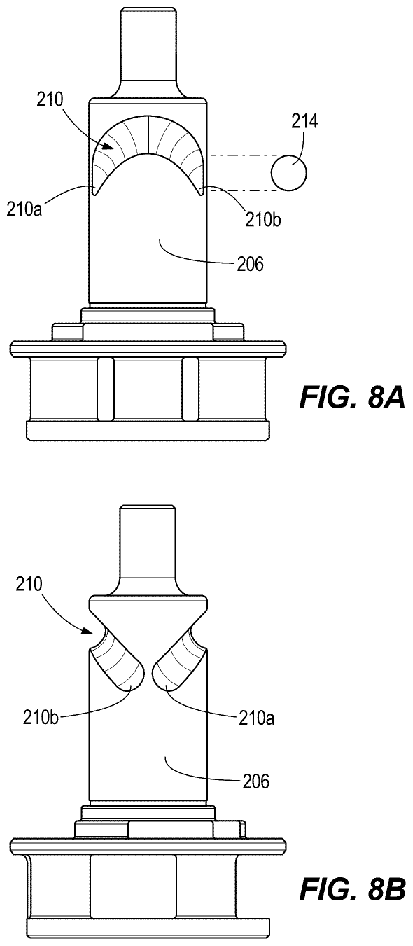

FIG. 7 is a graph 158 illustrating a position curve 162, a velocity curve 166, and an acceleration curve 170 for the camshaft 106 of the illustrated embodiment having the cam groove 122 (FIG. 4). With reference to FIGS. 4 and 7, a line A4 (FIG. 7) indicates the position of a transition point between the second groove portion 134 and the third groove portion 138 (e.g., where the second groove portion 134 and the third groove portion 138 meet) relative to the position, velocity, and acceleration curves 162, 166, 170 of the cam ball 126 traveling along the cam groove 122. Due to the cosine curve geometry of the third groove portion 138, the cam groove 122 does not include a step in the acceleration curve 170 that would otherwise cause a jerking movement of the cam ball 126, as observed with the conventional cam groove described above with reference to FIG. 6. Therefore, the acceleration of the cam ball 126 can smoothly drop to zero as the cam ball 126 travels from the third groove portion 138 to the second groove portion 134.

With reference to FIGS. 4 and 5, the variables C, D in the slope-intercept form equation and the variables E, F, G, H in the cosine equation are determined to align the second groove portion 134 and the third groove portion 138 based on a desired alpha angle R1 that minimizes the vibrations felt by the operator and efficiency losses from operation of the impact mechanism 42. Specifically, the variables C, D, E, F, G, H are determined so that the value of the slope-intercept form equation, which defines the second groove portion 134, and the value of the cosine curve equation, which defines the third groove portion 138, are equal at a transition point between the second groove portion 134 and the third groove portion 138 (i.e., a position along the cam groove 122 where the second groove portion 134 and the third groove portion 138 meet). In other words, the variables C, D, E, F, G, H are determined so that the second groove portion 134 and the third groove portion 138 are continuous at the transition point. The variables C, D, E, F, G, H are additionally determined so that the slope (i.e., the derivative) of the slope-intercept form equation, which defines the second groove portion 134, and the slope (i.e., the derivative) of the cosine curve equation, which defines the third groove portion 138, are equal at the transition point. In other words, the variables C, D, E, F, G, H are determined so that the second groove portion 134 and the third groove portion 138 are tangent at the transition point. As such, the orientation of the cam groove 122 is advantageously determined to enable the cam ball 126 to smoothly travel from the second groove portion 134 to the third groove portion 138 (and vice versa) without sudden jerks caused by impacts between the cam ball 126 and a step in the camshaft 106. The transition point between the second groove portion 134 and the third groove portion 138 may be referred to as a first or second transition point.

To determine the variables C, D, E, F, G, H based on a desired alpha angle R1, the slope-intercept form equation and the cosine curve equation are first solved based on a hypothetical transition point having values a and b. Value a is the x-coordinate of the transition point on an x-y coordinate system. Value b is the y-coordinate of the transition point on an x-y coordinate system. The x-y coordinate system is representative of a position on the outer surface of the camshaft 106 where the output axis A2 provides the y-axis. As such, the value a is equal to the value of the adjacent line in a triangle relative to the alpha angle R1, and the value b is equal to the value of the opposite line in the same triangle relative to the alpha angle R1. As such, the alpha angle R1 and the transition point are related by the following equation.

$$tan ( A 1 ) = \frac{b}{a}$$

Beginning with the variables E, F, G, H of the cosine curve equation, variable E, which represents the amplitude of the cosine curve, is determined based on the value b. Specifically, the variable E is set directly equal to value b. Variable F, which represents the period of the cosine curve, is determined based on the value a. Specifically, the variable E is set equal to π/(2a). Variable G, which represents the phase shift (e.g., shift along the x-axis of an x-y coordinate system) of the cosine curve, is set equal to zero so that the third groove portion 138 is centered at the output axis A2. In some embodiments, the phase shift may be set equal to a non-zero value so that the third groove portion 138 is not centered at the output axis A2. Variable H, which represents the vertical shift of the cosine curve, is determined based on the value a. Specifically, variable D is set directly equal to the value b. As such, the cosine curve may be simplified to the following equation.

$${y}_{1} = - ( b ) ( cos ( \frac{π}{2 a} x ) + b )$$

The variables C, D of the slope-intercept equation can then be determined using the equation y₁. Variable C, which represents the slope of the slope-intercept form equation, is determined from the derivative of the equation y₁. Specifically, since the second groove portion 134 and the third groove portion 138 are tangent at the hypothetical transition point, the slope of the slope-intercept form equation is set directly equal to the derivative of the equation y₁ at the hypothetical transition point. Therefore, after taking the derivative of the equation y₁ and solving the derivative at the hypothetical transition point, the variable C, or slope, is found to be (πb)/(2a). Variable D, which represents the y-intercept of the slope-intercept form equation, is determined according to both the value a and the value b. Specifically, variable D is determined by inserting value a in for x, value b in for y, and the derived value of variable C in for the slope, as described above. Therefore, by solving the slope-intercept form equation for variable D with these substitutions, variable D is found to be b−(πb)/(2). As such, the slope-intercept form equation may be simplified to the following equation.

$${y}_{2} = \frac{π b}{2 a} ( x ) + ( - b - \frac{π b}{2} )$$

Using the derived theoretical equations y₁, y₂, the actual equations for the second groove portion 134 and the third groove portion 138 may be determined by inserting a known or desired value (e.g., an independent variable) into the equations y₁, y₂. In the illustrated embodiment, the actual equations are determined by inserting a desired alpha angle R1, which determines the actual slope, in the derived equations y₁, y₂ and solving for the value a and the value b of the transition point using a system of equations. In some embodiment, the actual equations may be determined by inserting a known or desired transition point into the derived angles y₁, y₂ and solving for the alpha angle R1. The system of equations may include the equation y₁, the equation y₂, the derivative of the equation y₁, and the derivative of the equation y₂ and other relationships described herein. As such, once the equations y₁, y₂ are solved in view of the desired alpha angle R1, the second groove portion 134 and the third groove portion 138 may be formed (e.g., manufactured) in the camshaft 106 based on the resulting actual equations.

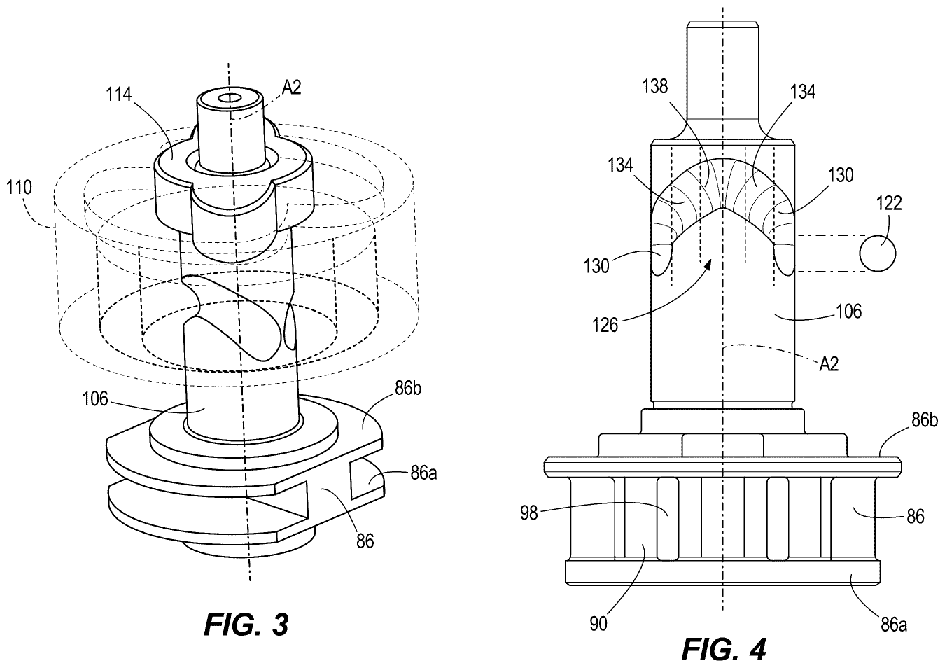

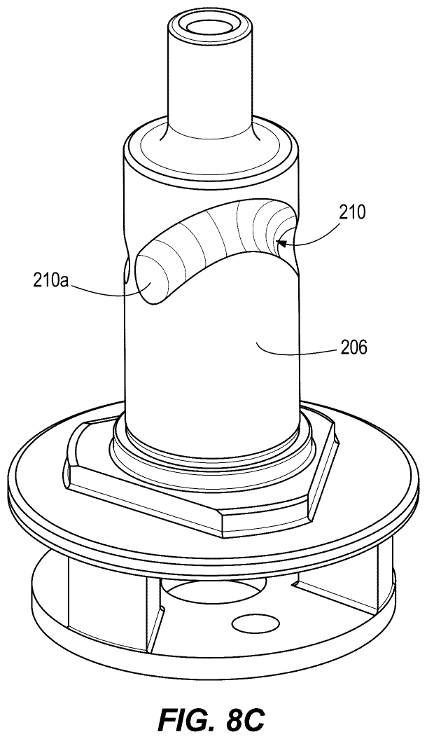

FIGS. 8A-8C illustrate another embodiment of a camshaft 206 for the power tool 10 of FIG. 1. The camshaft 206 may be substantially similar to the camshaft 106 of FIG. 4 except for the differences described herein. As illustrated in FIGS. 8A-8C, the camshaft 206 includes at least one cam groove 210 defined in the camshaft 206 that is configured to receive at least one cam ball 214. The cam ball 214 may be positioned in driving engagement with a hammer, such as the hammer 110 illustrated in FIG. 3. As such, movement of the cam ball 214 within the cam groove 210 allows for relative axial movement of the hammer along the camshaft 206. Specifically, the hammer is configured to move axially along the camshaft 206 to intermittently apply a striking rotational force, or rotational impact, on an anvil, such as the anvil 114 illustrated in FIG. 2.

The cam groove 210 is defined by one equation from a group of equations including trigonometric equations and higher order differential equations. Specifically, the cam groove 210 is uniformly formed according to the one equation from the group of equations including trigonometric equations and higher order differential equations. In the illustrated embodiment, the cam groove 210 is uniformly formed according to the equation of a cosine curve, as described above with respect to the third groove portion 138 illustrated in FIG. 4. Stated another way, the cam groove 210 of FIGS. 8A-8C is entirely defined by the equation of the cosine curve. As such, the cam ball 214 is allowed to smoothly travel between ends 210a, 210b of the cam groove 210 due to the uniformity of the cam groove 210. That is, the cam groove 210 does not include steps that would otherwise cause a jerking movement of the cam ball 214 as the cam ball 214 travels along the cam groove 210. In some embodiments, the cam groove 210 may be uniformly formed according to the equation of a sine curve. In other embodiments, the cam groove 210 may be uniformly formed according to the equation of a higher order differential equation.

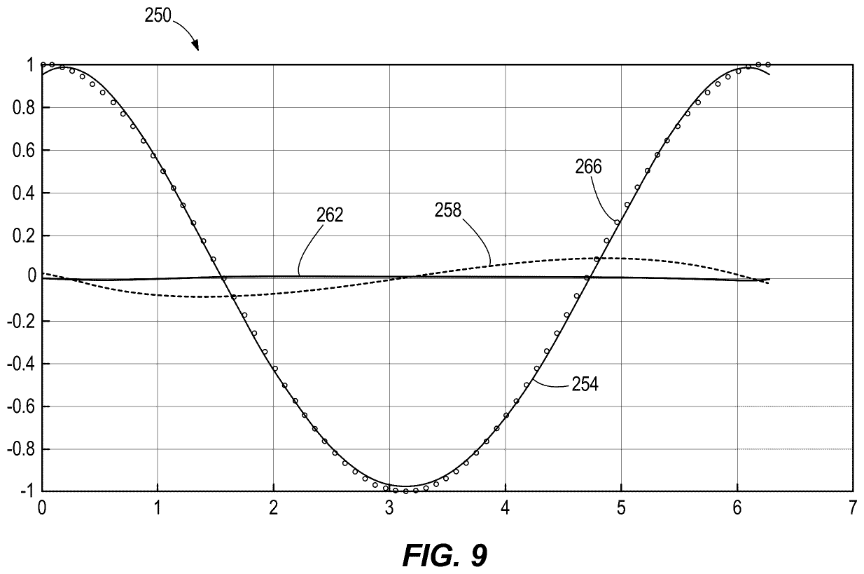

FIG. 9 is a graph 250 illustrating a position curve 254, a velocity curve 258, and an acceleration curve 262 for a camshaft according to another embodiment of the disclosure. The camshaft includes a cam groove that is uniformly formed according to a higher order differential equation. The higher order differential equation may be a second order, third order, fourth order, fifth order, or higher order differential equation. Specifically, the higher order differential equation may be manipulated such that the curvature of the position curve 254 mimics that of a sine curve or a cosine curve. As such, the graph 250 further includes a cosine curve 266 for reference relative to the position curve 254. In the illustrated embodiment, the position curve follows the equation for a general linear differential equation, as shown below.

$$L ( y ) = \frac{( {\partial }^{n} ) ( y )}{\partial ( t )} + {p}_{1} ( t ) \frac{( {\partial }^{n - 1} ) ( y )}{\partial ( t )} + {p}_{1 - n} ( t ) \frac{( \partial ) ( y )}{\partial ( t )} + {p}_{n} ( t ) ( y )$$

The above equation may be modified as necessary to extend substantially similarly to a trigonometric equation.

Various features and advantages of the invention are set forth in the following claims.

1. A power tool comprising:
a housing;
a motor supported within the housing and including an output shaft, the motor configured to rotationally drive the output shaft;
a transmission assembly configured to be rotationally driven by the output shaft; and
an impact mechanism including
a camshaft configured to be rotationally driven by the transmission assembly, the camshaft having a groove, at least a portion of the groove defined by an equation selected from a group consisting of: trigonometric equations and higher order differential equations,
a hammer coupled to the camshaft by a cam ball received in the groove, and
an anvil configured to receive intermittent rotational impacts from the hammer.

2. The power tool of claim 1, wherein the portion of the groove is defined by a cosine equation.

3. The power tool of claim 2, wherein the hammer is configured to rotationally impact the anvil when the cam ball is in the portion of the groove defined by the cosine equation.

4. The power tool of claim 1, wherein the portion of the groove is a first groove portion, and wherein the groove includes a second groove portion defined by a linear equation.

5. The power tool of claim 4, wherein the first groove portion and the second groove portion meet at a transition point, and wherein the first groove portion and the second groove portion are continuous and tangential at the transition point.

6. The power tool of claim 4, wherein the groove includes a third groove portion defined by an equation for a circle.

7. The power tool of claim 6, wherein the groove includes two second groove portions and the first groove portion extends between the two second groove portions, and wherein the groove includes two third groove portions and each of the third groove portions extends from a corresponding one of the second groove portions.

8. The power tool of claim 1, wherein the entire groove is defined by the equation selected from a group consisting of: trigonometric equations and higher order differential equations.

9. The power tool of claim 1, wherein the camshaft extends along an axis, and wherein the groove is mirrored across the axis.

10. A camshaft for an impact mechanism, the camshaft comprising:
a groove configured to receive a cam ball, the groove including
a first groove portion defined by a first equation,
a second groove portion defined by a second equation, and
a third groove portion defined by a third equation,
wherein at least one of the first equation, the second equation, and the third equation is an equation selected from a group consisting of: trigonometric equations and higher order differential equations.

11. The camshaft of claim 10, wherein only one of the first equation, the second equation, and the third equation is an equation selected from the group consisting of: trigonometric equations and higher order differential equations.

12. The camshaft of claim 10, wherein the first equation is a cosine equation having an amplitude, wherein the amplitude of the cosine equation defines a forward-most point of the groove, wherein the second groove portion extends from an end of the first groove portion opposite from the amplitude, and wherein the third groove portion extends from an end of the second groove portion opposite from the first groove portion.

13. The camshaft of claim 12, wherein the camshaft extends along an axis, and wherein the groove is mirrored across the axis such that the groove includes two second groove portions and two third groove portions.

14. The camshaft of claim 12, wherein the second equation is a linear equation, and wherein the third equation is an equation for a circle.

15. The camshaft of claim 10, wherein each of the first equation, the second equation, and the third equation are different types of equations.

16. A power tool comprising:
a housing;
a motor supported within the housing and including an output shaft, the motor configured to rotationally drive the output shaft;
a transmission assembly configured to be rotationally driven by the output shaft; and
an impact mechanism including
a camshaft configured to be rotationally driven by the transmission assembly, the camshaft having a groove with a first groove portion and a second groove portion that meet at a transition point, the first groove portion and the second groove portion being continuous and tangential at the transition point,
a hammer coupled to the camshaft by a cam ball received in the groove, and
an anvil configured to receive intermittent rotational impacts from the hammer.

17. The power tool of claim 16, wherein the first groove portion is defined by a first equation and the second groove portion is defined by a second equation, and wherein the first equation and the second equation are different.

18. The power tool of claim 17, wherein one of the first equation and the second equation is an equation selected from a group of equations consisting of: trigonometric equations and higher order differential equations, and wherein the other of the first equation and the second equation is a linear equation.

19. The power tool of claim 16, wherein the transition point is a first transition point, wherein the groove further includes a third groove portion such that the second groove portion and the third groove portion meet at a second transition point, and wherein the second groove portion and the third groove portion are continuous and tangential at the second transition point.

20. The power tool of claim 19, wherein each of the first groove portion, the second groove portion, and the third groove portion is defined by a different equation from the others of the first groove portion, the second groove portion, and the third groove portion.
